(19) United States
(12) Patent Application Publication
(10) Pub. No.: US 2022/0194187 A1
(43) Pub. Date: Jun. 23, 2022

(54) DIMMING LIGHT THAT IS INTERFERING WITH AN OBSERVER'S VISION

(71) Applicant: ams Sensors Singapore Pte. Ltd., Singapore (SG)

(72) Inventor: Olivier Ripoll, Ruschlikon (CH)

(21) Appl. No.: 17/605,443

(22) PCT Filed: May 14, 2020
(86) PCT No.: PCT/SG2020/050278

§ 371 Date: Oct. 21, 2021

Related U.S. Application Data
(60) Provisional application No. 62/849,234, filed on May 17, 2019.

(51) Int. Cl. B60J 3/04; G02F 1/157; G02F 1/163; G02F 1/133; G06F 3/01

(52) U.S. Cl. CPC B60J 3/04; G02F 1/157; G06F 3/013; G02F 1/13318; G02F 1/163

(57) ABSTRACT

The current disclosure describes a system for dimming sunlight that interferes with an observer's vision. A position of an observer's eyes and a position of the sun relative to a transparent screen are determined, and, based on the position of the observer's eyes and the position of the sun, an area of the transparent screen where light emitted by the sun intersects the transparent screen before reaching the position of the observer's eyes is identified. The system causes the area of the transparent screen to be modified such that the light emitted by the sun is dimmed in the area of the transparent screen.

### FIELD OF THE DISCLOSURE

This disclosure relates to dimming sunlight that interferes with an observer's vision.

### BACKGROUND

Generally, the sun's brightness (e.g., during daytime) is many orders of magnitude brighter than other light. While the human eye evolved to adjust to a wide range of brightness, it cannot cope well with the presence of such a strong light source and forcibly staring in a direction close to that of the sun results in temporary or permanent loss of sensitivity. This can be inconvenient in the situations where one must, or wants, to look in a direction close to that of the sun. For example, when one is driving a vehicle or flying an airplane, the sun's brightness can be extremely inconvenient. Another example when the sun's brightness can be extremely inconvenient is when looking through a window at an outside environment.

The current solutions include providing an adjustable screen that obstructs a wide portion of the field-of-view (e.g., a sun visor in a vehicle) or applying tinting film to a windshield or at least a large portion of the windshield. These solutions present a number of issues. For example, in addition to obstructing a wide portion of the field-of-view, a sun visor requires constant readjustment by the driver (e.g., when the vehicle changes direction). Applying tinting material also can be problematic because it makes driving in less-than-optimal driving conditions more difficult, due to more light being blocked.

### SUMMARY

The current disclosure describes an automatic dimming system that, in some instances, addresses at least some of the problems mentioned above. The automatic dimming system may be built into, for example, a vehicle, an airplane, or a window, and in some instances may be a module that can be connected to a transparent screen. The transparent screen may be, for example, a vehicle's windshield, an airplane's windshield, a window or another suitable screen. The automatic dimming system is operable to determine a position of an observer's eyes relative to the transparent screen.

For example, the automatic dimming system may use an imaging device (e.g., a camera) that tracks an observer's eyes to determine the eyes' position relative to the transparent screen. The imaging device may be part of the automatic dimming system or may be available to the automatic dimming system. In some embodiments, the automatic dimming system determines, using the imaging device, a vertical coordinate of the observer's eyes relative to the imaging device, and a horizontal coordinate of the observer's eyes relative to the imaging device. For example, the automatic dimming system may track a relative vertical and horizontal distances to the eyes' position. In some embodiments, the automatic dimming system determines a direction to the observer's eyes (e.g., because the observer may not be sitting exactly in front of the imaging device). The automatic dimming system stores the vertical coordinate and the horizontal coordinate as the position of the observer's eyes. In some embodiments, the automatic dimming system also stores the direction of the observer's eyes.

In some embodiments, the automatic dimming system receives an input from an observer that indicates the position of the observer's eyes. For example, if the automatic dimming system is built into a vehicle, the position of the observer's eyes may be determined in a manner similar to setting a position of a mirror. The observer may look at a specific point and adjust that point to match with the observer's eyes. In some embodiments, the automatic dimming system receives input from the observer, the input indicating the position of the observer's eyes. Based on the input, the automatic dimming system determines a vertical coordinate of the observer's eyes and a horizontal coordinate of the observer's eyes, and stores, as a position of the observer's eyes, the vertical coordinate and the horizontal coordinate. In some embodiments, the automatic dimming system receives input that indicates a direction of the observer's eyes and stores that direction together with the horizontal coordinate and the vertical coordinate.

In addition, the automatic dimming system can be operable to determine a position of the sun relative to the transparent screen. For example, the automatic dimming system may use an imaging device (or, in some instances, multiple imaging devices) to determine the position of the sun. In some embodiments, the automatic dimming system captures an image using the imaging device (e.g., a camera or multiple cameras), and identifies the sun in the captured image. When the sun is identified, the automatic dimming system calculates, based on the captured image, a vector representing the sun's position relative to the imaging device. For example, the automatic dimming system may determine an angle of the sun and direction to the sun. In some embodiments, the vector may include an angle between the horizontal axis and an axis created between the imaging device and the sun's position, and a direction to the sun (e.g., a horizontal angle between the direction that the imaging device is facing and the sun). In some embodiments, the imaging device is operable to determine a position of another light source (i.e., other than the sun) that may be interfering with the observer's vision. For example, the imaging device can be operable to detect a light source that is emitting a bright light (e.g., lights of another vehicle, street lights, or another suitable light) that interferes with the observer's vision.

In some embodiments, the automatic dimming system determines the position of the sun based on time of day and orientation of the object into which the automatic dimming system is built. For example, using the Global Positioning System (“GPS”), the automatic dimming system may determine a location of the object (e.g., a vehicle) and a time of day at that location. The automatic dimming system may use a gyroscope, an accelerometer or a combination of the two to determine the orientation of the object and, based on that orientation, the position of the sun. These instruments may be a part of a positioning device or positioning device modules. The automatic dimming system may detect, using the positioning device (or multiple positioning devices), a position and an orientation of the transparent screen, and based on the position and the orientation and time of day, determine the position of the sun relative to the positioning device. In some embodiments, the position of the sun may be represented by a vector. The vector may include an angle between the horizontal axis and an axis created between the positioning device and the sun's position, and a direction.

In some embodiments, the automatic dimming system is able to use an observer's electronic device that includes a GPS module, a gyroscope, and or an accelerometer. The automatic dimming system may detect an electronic device (e.g., an electronic device associated with the observer). For example, the observer may have registered his or her smartphone with a vehicle that includes the automatic dimming system. When the automatic dimming system is initialized, it may detect the registered smartphone. The automatic dimming system may determine, for example, that the electronic device includes a global positioning system module and an accelerometer, and may set the electronic device as the positioning device (e.g., use the electronic device as the positioning device).

Based on the position of the observer's eyes and the position of the sun, the automatic dimming system identifies an area of the transparent screen where light emitted by the sun intersects the transparent screen before reaching the position of the observer's eyes. For example, the automatic dimming system may identify an area on a windshield of a vehicle where sunlight intersects the windshield before reaching the driver's eyes. Upon identification of the area, the automatic dimming system causes the area of the transparent screen to be modified such that the light emitted by the sun is dimmed in the area of the transparent screen.

In some embodiments, the automatic dimming system identifies the area of the transparent screen where light emitted by the sun intersects the transparent screen before reaching the position of the observer's eyes by performing the following actions. If the sun's position is stored as a vector representing the sun's position relative to the imaging device, the automatic dimming system modifies, based on the position of the observer's eyes, the vector such that the vector represents the sun's position relative to the observer's eyes, instead of being relative to the imaging device. For example, the automatic dimming system may use the vertical coordinate and the horizontal coordinate that represents the position of the observer's eyes relative to the imaging device to calculate the sun's position relative to the observer's eyes using the data representing the sun's position relative to the imaging device.

In some embodiments, the automatic dimming system identifies the area of the transparent screen where light emitted by the sun intersects the transparent screen before reaching the position of the observer's eyes by performing the following actions. The automatic dimming system modifies, based on the position of the observer's eyes, the vector such that the vector represents the sun's position relative to the observer's eyes. For example, the automatic dimming system may use coordinates input by the observer at an earlier time to determine the position of the observer's eyes and modify the vector accordingly. The automatic dimming system then identifies, using the vector, a point on the transparent screen where the light emitted by the sun intersects the transparent screen before reaching the position of the observer's eyes, and selects an area proximate to the point. For example, in some cases, the automatic dimming system identifies a point on a window of the building where sunlight intersects the window prior to reaching the observer's eyes, and the system calculates an area (e.g., a circular area) to be dimmed around that point.

In some embodiments, the automatic dimming system uses the direction to the observer's eyes in the calculation (e.g., if the observer is not located directly in front of the imaging device, but at an angle). In some embodiments, the automatic dimming system modifies the vector based on a shape associated with the transparent screen. For example, if the vehicle's windshield is curved, the automatic dimming system can take into account the curvature of the windshield to identify the correct area.

In some embodiments, the automatic dimming system selects an area proximate to the point where the light from the sun intersects the transparent screen before reaching the observer's eyes by performing the following actions. The automatic dimming system determines, using an imaging device (e.g., a camera), an area associated with the observer's eyes. For example, the automatic dimming system may determine how far apart the eyes are or, in some embodiments, how big the observer's face is. The automatic dimming system selects the area proximate to the point based on the area associated with the observer's eyes. For example, for people with a relatively large distance between eyes or, in some embodiments, larger faces, the control circuitry selects a larger area.

In some embodiments, the automatic dimming system identifies, using the vector, a point on the transparent screen where the light emitted by the sun intersects the transparent screen before reaching the position of the observer's eyes, and selects an area proximate to the point. For example, the automatic dimming system may identify a point on a windshield of the vehicle where sunlight intersects the windshield prior to reaching the observer's eyes and calculates an area (e.g., a circular area) to be dimmed around that point.

In some embodiments, the automatic dimming system modifies the identified area by applying current to a portion of a matrix of electrochromic material integrated into the transparent screen, where each portion of the matrix of electrochromic material is addressable. For example, a vehicle's windshield may include a layer of addressable electrochromic material. That is, electrical current may be applied to one or more specific areas of the electrochromic material. The automatic dimming system may be configured to apply the current to those addresses in the electrochromic material that correspond to the identified area.

In some embodiments, the automatic dimming system applies a current to a portion of a matrix of liquid crystal material, where each portion of the matrix of liquid crystal material is addressable. For example, a window may include a layer of liquid crystal material that is addressable (i.e., current may be applied to one or more different areas of the crystal material). The automatic dimming system may be configured to apply the current to those addresses that correspond to the identified area of the window.

In some embodiments, the automatic dimming system projects an electromagnetic beam onto the portion of the transparent screen, where the transparent screen includes material that dims light emitted by the sun when the electromagnetic beam is projected onto the material. For example, if the automatic dimming system is installed in a vehicle, the vehicle may be equipped with an ultraviolet light emitter that is able to emit a beam of ultraviolet light unto the area of the windshield where sunlight intersects with the windshield before reaching the driver's eyes. In this instance, the windshield is also modified to enable the ultraviolet light to block at least some of the sunlight reaching the windshield.

The details of one or more implementations are set forth in the accompanying drawings and the detailed description below. Other features and advantages will be apparent from the detailed description, the accompanying drawings, and the claims.

### BRIEF DESCRIPTION OF DRAWINGS

FIG. 1 illustrates a computer system 100 that may be used in dimming sunlight that interferes with an observer's vision.

FIG. 2 is a block diagram that illustrates actions for dimming sunlight that interferes with an observer's vision.

FIG. 3 illustrates an example of a system for detecting an area on a transparent screen for dimming sunlight that interferes with an observer's vision.

FIG. 4 illustrates another example of a system for detecting an area on a transparent screen for dimming sunlight that interferes with an observer's vision.

FIG. 5 illustrates an example of a system for dimming sunlight that interferes with an observer's vision.

### DETAILED DESCRIPTION

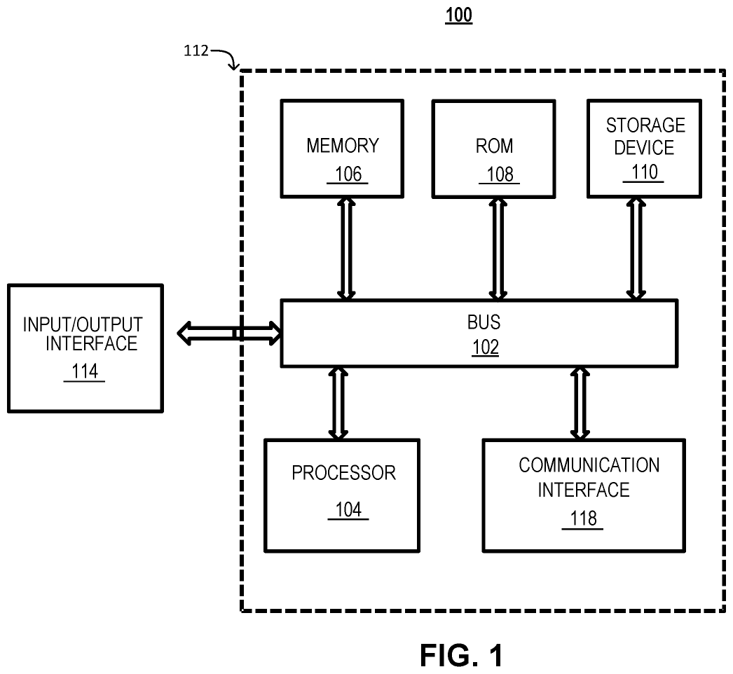

FIG. 1 illustrates a computer system that may be used in dimming sunlight that interferes with an observer's vision. In some implementations, computer system 100 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices include desktop computer systems, portable computer systems, handheld devices, network devices or any other device that incorporates hard-wired and/or program logic to implement the techniques.

Computer system 100 may include a bus 102 or other communication mechanism for communicating information, and a hardware processor 104 coupled with a bus 102 for processing information. The hardware processor 104 can include, for example, a general-purpose microprocessor. Computer system 100 also includes memory 106, such as a random-access memory (RANI) or other dynamic storage device, coupled to the bus 102 for storing information and instructions to be executed by processor 104. In one implementation, the memory 106 is used for storing temporary variables or other intermediate information during execution of instructions to be executed by the processor 104. Such instructions, when stored in non-transitory storage accessible to processor 104, render the computer system 100 into a special-purpose machine that is customized to perform the operations specified in the instructions.

Computer system 100 further includes a read only memory (ROM) 108 or other static storage device coupled to the bus 102 for storing static information and instructions for the processor 104. A storage device 110, such as a magnetic disk, optical disk, solid-state drive, or three-dimensional cross point memory is provided and coupled to the bus 102 for storing information and instructions.

According to some embodiments, the techniques herein are performed by computer system 100 in response to the processor 104 executing one or more sequences of one or more instructions contained in memory 106. Such instructions may be read into memory 106 from another storage medium, such as the storage device 110. Execution of the sequences of instructions contained in the main memory 106 causes the processor 104 to perform the process steps described herein. In some embodiments, hard-wired control circuitry is used in place of or in combination with software instructions.

In some embodiments, computer system 100 also includes a communication interface 118 coupled to the bus 102. Communication interface 118 provides a two-way data communication (e.g., with other devices). In some implementations, communication interface 118 sends and receives electrical, electromagnetic, or optical signals that carry digital data streams representing various types of information. Communication interface 118 may support a variety of protocols. For example, the communications interface may support Bluetooth, WiFi, USB, and other suitable protocols for connecting an external electronic device to computer system 100.

In some embodiments, computer system 100 includes an input/output interface 114. Interface 114 may be used by the computer system to communicate with external devices (e.g., peripherals including imaging devices, positioning devices, and other suitable devices. In some embodiments, one or more of components 102, 104, 106, 108, 110, 114, and 118 are combined to form control circuitry 112.

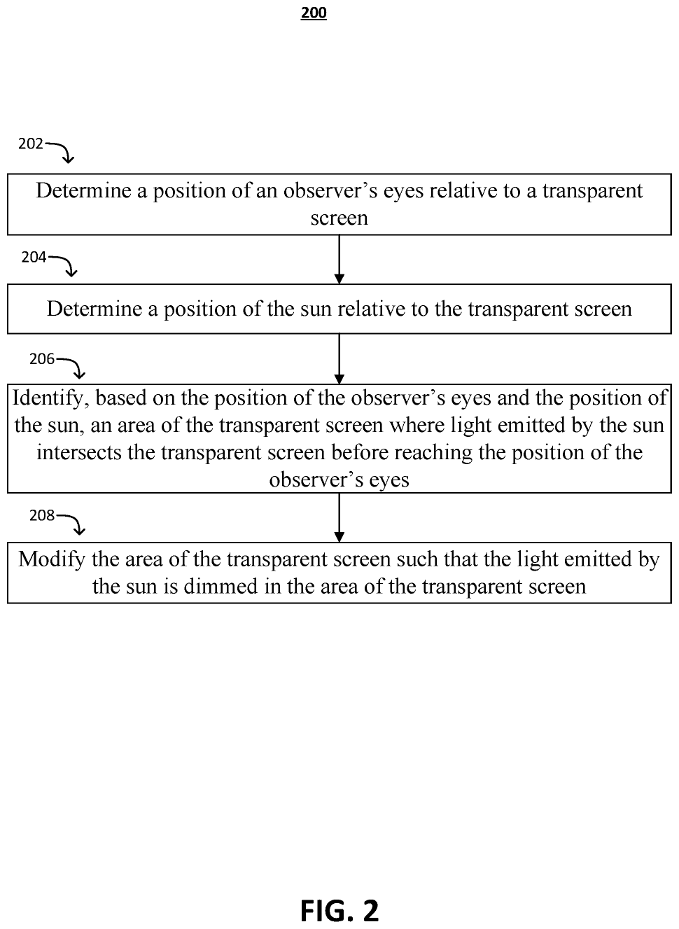

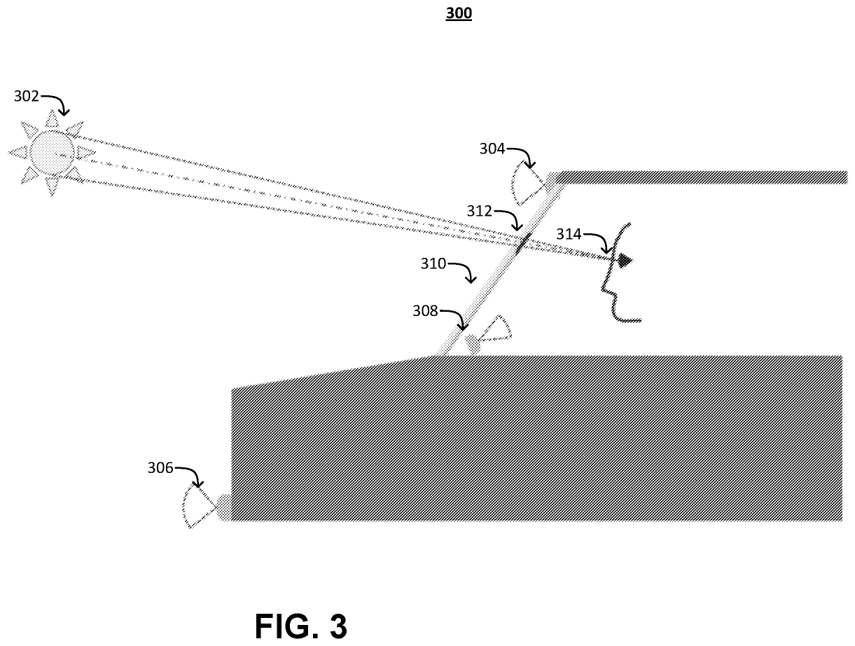

FIG. 2 is a block diagram of process 200 for dimming sunlight that interferes with an observer's vision. As shown in block 202, control circuitry (e.g., control circuitry 112) determines a position of an observer's eyes relative to a transparent screen. For example, the control circuitry may be coupled (e.g., via input/output interface 114) with an imaging device. As shown in illustration 300 of FIG. 3, imaging device 308 (e.g., a camera) may capture images of the observer's eyes (e.g., area 314). The control circuitry receives images from the imaging device (e.g., imaging device 308) and determines, based on the images, a vertical coordinate of the observer's eyes relative to the imaging device, and a horizontal coordinate of the observer's eyes relative to the imaging device. For example, the imaging device may use a time-of-flight (ToF) technique to determine distance to the observer's eyes and then based on the distance and angle to the observer's eyes to determine the horizontal coordinate and the vertical coordinate. The control circuitry may store (e.g., in memory 106 and/or storage device 110) the vertical coordinate and the horizontal coordinate as the position of the observer's eyes.

In some embodiments, control circuitry 112 determines the position of the observer's eyes based on settings input by the user. Specifically, the control circuitry may receive input from the observer, the input indicating the position of the observer's eyes. For example, the control circuitry may cause a light to be emitted indicating a position of the observer's eyes. In such cases, the control circuitry can cause the observer to be prompted (e.g., using input/output interface 114) to manipulate the position of the light so that it is located at the same place as the observer's eyes. Based on the input, the control circuitry determines a vertical coordinate of the observer's eyes and a horizontal coordinate of the observer's eyes. The control circuitry then stores (e.g., in memory 106 and/or storage device 110), as a position of the observer's eyes, the vertical coordinate and the horizontal coordinate.

As shown in block 204, control circuitry 112 determines a position of the sun relative to the transparent screen. For example, the control circuitry may use one or more imaging devices to make the determination. As shown in FIG. 3, sun 302 emits light onto transparent screen 310 (i.e., a windshield of a vehicle). Although, FIG. 3 shows transparent screen as a windshield of a vehicle, this disclosure is not limited to being used in connection with a vehicle. For example, transparent screen may be a window of a building, a windshield of an airplane, or another suitable screen. The control circuitry may receive images from imaging devices 304 and 306 and process the images to determine the position of the sun. In some embodiments, only one imaging device may be used. For example, the control circuitry may transmit a command to imaging device 304 to capture one or more images of the outside of the vehicle. Based on the one or more images, the control circuitry determines the position/location of the sun. In some embodiments, the control circuitry is configured to detect other light sources (i.e., other than the sun) that emit light that interferes with the observer's vision. For example, the control circuitry may receive from the imaging device data that indicates a number of lumens detected from various direction and determine based on the number of lumens from a specific direction meets a threshold intensity. Based on the detecting a light source that meets the threshold intensity, the control circuitry may perform dimming action(s) in a manner similar to that of dimming sunlight. In some implementations, the threshold intensity may vary based on the level of light in the surround environment. For example, if the surrounding environment does not have too much other light (e.g., at night time) the threshold intensity may be decreased. In another example, if the surround environment has lots of other light (e.g., during daytime), the threshold intensity may be increased. In some implementations, the imaging device may detect the size of the observer's pupil(s) and based on that size set the threshold intensity. That is, if the pupil is large (i.e., the iris is enabling a large area of the pupil to absorb light), the threshold intensity may be set a larger number. However, if the pupil is small (i.e., the iris is enabling a small area of the pupil to absorb light), the threshold intensity may be set to a smaller number.

In some embodiments, control circuitry 112 determines the position of the sun using following actions. The control circuitry may capture an image using an imaging device (e.g., imaging device 306 and/or imaging device 304 and may identify the sun in the captured image (e.g., using a technique like edge detection). In some embodiments, the control circuitry uses a neural network for identifying the sun in the captured image. Based on the captured image, the control circuitry can calculate a vector representing the sun's position relative to the imaging device (e.g., imaging device 304 and/or imaging device 306). The vector may include an angle between the horizontal axis and an axis created between the imaging device and the sun's position, and also may include a direction.

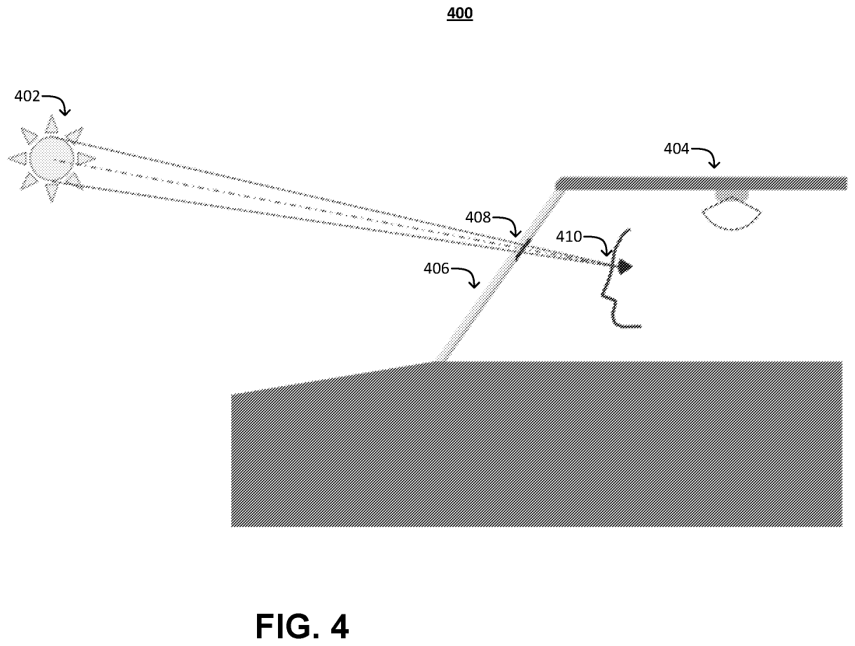

In some embodiments, the control circuitry (e.g., control circuitry 112) determines the direction of the sun relative to the transparent screen by performing the following actions. The control circuitry may detect, using the positioning device, a position and an orientation of the transparent screen. As shown in illustration 400 of FIG. 4, sun 402 emits light that intersects transparent screen 406 at area 408 before reaching the observer's eyes 410. Positioning device 404 is coupled with the control circuitry (e.g., through input/output interface 114). The positioning device may have the ability to determine its location. For example, the positioning device may include a global positioning system (“GPS”) module that may use satellite data to determine a location of the module. Positioning device 404 may also include a gyroscope and/or accelerometer to determine the direction of the sun. The control circuitry may receive (e.g., via input/output interface 114) GPS data from the positioning device together with gyroscope and/or accelerometer data. Based on the time of day and the position and the orientation of the sun, the control circuitry may determine the position of the sun relative to the positioning device (e.g., in a form of a vector). The vector may include an angle between the horizontal axis and an axis created between the positioning device and the sun's position, and a direction of the sun.

In some embodiments, the control circuitry uses an observer's electronic device as the positioning device. For example, the control circuitry may detect, via communication interface 118, an electronic device associated with the observer. The control circuitry may detect the device using, for example, the Bluetooth protocol, the WiFi protocol, or another suitable protocol. In some embodiments, the electronic device may have been pre-registered by the observer. In such instances, the control circuitry may determine that the electronic device includes a global positioning system module and an accelerometer, and set the electronic device as the positioning device. For example, the observer may have a smartphone. Communication interface 118 may detect the smartphone and receive data from the smartphone indicating that the smartphone includes a GPS module and an accelerometer. In some embodiments, the communication interface may receive data from the smartphone indicating that a gyroscope and/or an accelerometer is present within the smartphone. The smartphone may transmit GPS coordinates and/or other data to system 100 through communication interface 118.

As shown in block 206, control circuitry 112 identifies, based on the position of the observer's eyes and the position of the sun, an area of the transparent screen where light emitted by the sun intersects the transparent screen before reaching the position of the observer's eyes. Area 312 of FIG. 3 illustrates the area of the transparent screen light where light emitted by the sun intersects the transparent screen before reaching the position of the observer's eyes. In some embodiments, the control circuitry uses a vector for the sun's position relative to an imaging device (e.g., imaging device 304 and/or imaging device 306) and the vertical and horizontal coordinates of the observer's eyes relative to the transparent screen (e.g., transparent screen 310) in identifying area 312. Specifically, the control circuitry may modify, based on the position of the observer's eyes, the vector such that the vector represents the sun's position relative to the observer's eyes. For example, the control circuitry may calculate a new vector to the observer's eyes using algebraic functions.

Control circuitry 112 may identify, using the modified vector, a point on the transparent screen where the light emitted by the sun intersects the transparent screen before reaching the position of the observer's eyes. For example, the control circuitry may calculate using algebraic functions the location of area 312 on transparent screen 310. In some embodiments, the control circuitry modifies the vector based on a shape associated with the transparent screen. For example, if a vehicle's windshield is curved, the control circuitry may take into account the curvature of the windshield when performing calculations. The control circuitry may select an area (e.g., area 312) proximate to the point.

In some embodiments, when selecting an area proximate to the point, the control circuitry takes into account an area that includes both of the observer's eyes. Specifically, the control circuitry may determine, using the imaging device (e.g., imaging device 308), an area associated with the observer's eyes, and select the area proximate to the point based on the area associated with the observer's eyes. For example, area 312 may correspond in size to the size of the area between the observer's eyes.

In some embodiments, control circuitry (e.g., control circuitry 112) identifies the area of the transparent screen where light emitted by the sun intersects the transparent screen before reaching the position of the observer's eyes by performing the following actions. The control circuitry modifies, based on the position of the observer's eyes, the vector such that the vector represents the sun's position relative to the observer's eyes. As discussed above, the control circuitry may use algebraic functions to modify the vector. The control circuitry may identify, using the vector, a point on the transparent screen where the light emitted by the sun intersects the transparent screen before reaching the position of the observer's eyes, and select an area proximate to the point.

The control circuitry may select an area proximate to the point by determining, from the input, an area associated with the observer's eyes, and selecting the area proximate to the point based on the area associated with the observer's eyes. For example, the control circuitry may determine area 408 based on the area between the observer's eyes.

As shown in block 208, the control circuitry (e.g., control circuitry 112) modifies the area of the transparent screen such that the light emitted by the sun is dimmed as it passes through the area of the transparent screen. The control circuitry may modify the area of the transparent screen using various ways. The control circuitry may apply electrical current to a portion of a matrix of electrochromic material integrated into the transparent screen, where each portion of the matrix of electrochromic material is addressable. In some embodiments, the transparent screen includes two layers separated by an electrolytic layer. The control circuitry may cause voltage to be applied to the electrodes at a specific location in order to cause a dimming affect. In some embodiments, control circuitry 112 causes application of a current to a portion of a matrix of liquid crystal material, where each portion of the matrix of liquid crystal material is addressable.

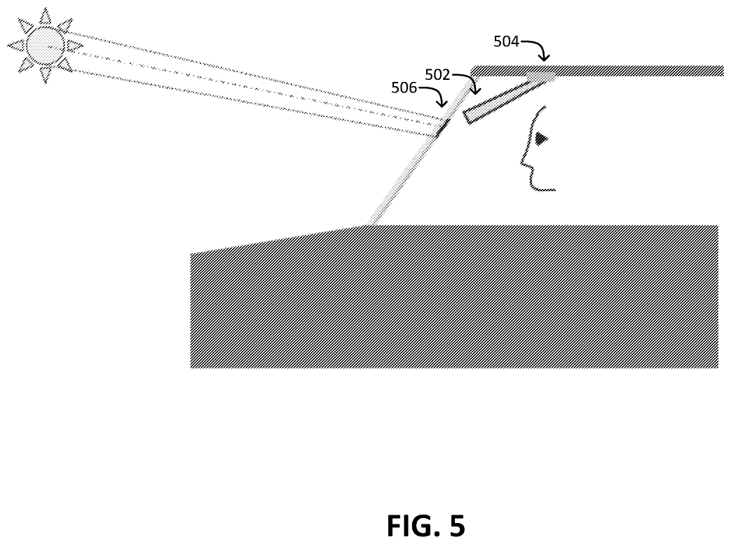

In some embodiments, the control circuitry may cause a projection of an electromagnetic beam onto the portion of the transparent screen, where the transparent screen includes material that dims light emitted by the sun when the electromagnetic beam is projected onto the material. FIG. 5 illustrates a transmitting device 504 that transmits an electromagnetic beam 502 onto area 506. An electromagnetic beam may be a beam of light of specific frequency (e.g., visible light), an ultraviolet light, an infrared light, or another suitable beam.

Various aspects of the subject matter and the functional operations described in this disclosure can be implemented in digital electronic circuitry, or in software, firmware, or hardware, including the structures disclosed in this specification and their structural equivalents, or in combinations of one or more of them. In addition, aspects of the subject matter described in this disclosure can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous.

A number of embodiments have been described. Nevertheless, it will be understood that various modifications may be made without departing from the spirit and scope of the invention. For example, some of the steps described above may be order independent, and thus can be performed in an order different from that described.

Accordingly, other implementations are within the scope of the claims.

1. A system comprising:
a transparent screen; and
control circuitry configured to:
determine a position of an observer's eyes relative to the transparent screen;
determine a position of a light source relative to the transparent screen;
identify, based on the position of the observer's eyes and the position of the light source, an area of the transparent screen where light emitted by the light source intersects the transparent screen before reaching the position of the observer's eyes; and
cause the area of the transparent screen to be modified such that the light emitted by the light source is dimmed in the area of the transparent screen.

2. The system of claim 1, further comprising an imaging device coupled to the transparent screen, wherein the control circuitry is configured to determine the position of the observer's eyes relative to the transparent screen by performing actions including:
determining, using the imaging device, a vertical coordinate of the observer's eyes relative to the imaging device, and a horizontal coordinate of the observer's eyes relative to the imaging device; and
storing as the position of the observer's eyes the vertical coordinate and the horizontal coordinate.

3. The system of claim 2, wherein the control circuitry is configured to determine the position of the light source relative to the transparent screen by performing actions including:
capturing an image using the imaging device;
identifying the light source in the captured image; and
calculating, based on the captured image, a vector representing the light source's position relative to the imaging device; and, optionally:
wherein the vector comprises (1) an angle between the horizontal axis and an axis created between the imaging device and the light source's position, and (2) a direction.

4. (canceled)

5. The system of claim 3, wherein the control circuitry is configured to identify the area of the transparent screen where light emitted by the light source intersects the transparent screen before reaching the position of the observer's eyes by performing actions including:
modifying, based on the position of the observer's eyes, the vector such that the vector represents the light source's position relative to the observer's eyes;
identifying, using the vector, a point on the transparent screen where the light emitted by the light source intersects the transparent screen before reaching the position of the observer's eyes; and
selecting an area proximate to the point; and, optionally wherein the control circuitry is further configured to modify the vector based on a shape associated with the transparent screen.

6. (canceled)

7. The system of claim 5, wherein the control circuitry is configured to select an area proximate to the point by performing actions including:
determining, using the imaging device, an area associated with the observer's eyes; and
selecting the area proximate to the point based on the area associated with the observer's eyes.

8. The system of claim 1, wherein the control circuitry is configured to determine the position of the observer's eyes relative to the transparent screen by performing actions including:
receiving input from the observer, the input indicating the position of the observer's eyes;
based on the input, determining a vertical coordinate of the observer's eyes and a horizontal coordinate of the observer's eyes; and
storing, as a position of the observer's eyes, the vertical coordinate and the horizontal coordinate.

9. The system of claim 8, further comprising a positioning device, wherein the control circuitry is further configured to determine the direction of the light source relative to the transparent screen by performing actions including:
detecting, using the positioning device, a position and an orientation of the transparent screen; and
based on the position and the orientation and time of day, determining the position of the light source relative to the positioning device, wherein the position of the light source comprises a vector; and, optionally:
wherein the vector comprises (1) an angle between the horizontal axis and an axis created between the positioning device and the light source's position, and (2) a direction.

10. (canceled)

11. The system of claim 9, wherein the control circuitry is further configured to:
detect an electronic device;
determine that the electronic device includes a global positioning system module and an accelerometer; and
set the electronic device as the positioning device.

12. The system of claim 8, wherein the control circuitry is configured to identify the area of the transparent screen where light emitted by the light source intersects the transparent screen before reaching the position of the observer's eyes by performing actions including:
modifying, based on the position of the observer's eyes, the vector such that the vector represents the light source's position relative to the observer's eyes;
identifying, using the vector, a point on the transparent screen where the light emitted by the light source intersects the transparent screen before reaching the position of the observer's eyes; and
selecting an area proximate to the point; and, optionally:
wherein the control circuitry is configured to select an area proximate to the point by performing actions including:
determining, from the input, an area associated with the observer's eyes; and
selecting the area proximate to the point based on the area associated with the observer's eyes.

13. (canceled)

14. The system of claim 1, wherein the control circuitry is configured to cause the area of the transparent screen to be modified such that the light emitted by the light source is dimmed in the area of the transparent screen by performing actions including one or more of:
applying current to a portion of a matrix of electrochromic material integrated into the transparent screen, wherein each portion of the matrix of electrochromic material is addressable;
applying a current to a portion of a matrix of liquid crystal material, wherein each portion of the matrix of liquid crystal material is addressable; or
projecting an electromagnetic beam onto the portion of the transparent screen, wherein the transparent screen comprises material that dims light emitted by the light source when the electromagnetic beam is projected onto the material.

15. A method comprising:
determining a position of an observer's eyes relative to a transparent screen;
determining a position of the light source relative to the transparent screen;
identifying, based on the position of the observer's eyes and the position of the light source, an area of the transparent screen where light emitted by the light source intersects the transparent screen before reaching the position of the observer's eyes; and
causing the area of the transparent screen to be modified such that the light emitted by the light source is dimmed in the area of the transparent screen.

16. The method of claim 15, wherein determining the position of the observer's eyes relative to the transparent screen comprises:
determining, using an imaging device, a vertical coordinate of the observer's eyes relative to the imaging device, and a horizontal coordinate of the observer's eyes relative to the imaging device; and
storing as the position of the observer's eyes the vertical coordinate and the horizontal coordinate.

17. The method of claim 16, wherein determining the position of the light source relative to the transparent screen comprises:
capturing an image using the imaging device;
identifying the light source in the captured image; and
calculating, based on the captured image, a vector representing the light source's position relative to the imaging device; and, optionally:
wherein the vector comprises (1) an angle between the horizontal axis and an axis created between the imaging device and the light source's position, and (2) a direction.

18. (canceled)

19. The method of claim 17, wherein identifying the area of the transparent screen where light emitted by the light source intersects the transparent screen before reaching the position of the observer's eyes comprises:
modifying, based on the position of the observer's eyes, the vector such that the vector represents the light source's position relative to the observer's eyes;
identifying, using the vector, a point on the transparent screen where the light emitted by the light source intersects the transparent screen before reaching the position of the observer's eyes; and
selecting an area proximate to the point; and, optionally:
the method further comprising modifying the vector based on a shape associated with the transparent screen.

20. (canceled)

21. The method of claim 19, wherein selecting an area proximate to the point comprises:
determining, using the imaging device, an area associated with the observer's eyes; and
selecting the area proximate to the point based on the area associated with the observer's eyes.

22. The method of claim 15, wherein determining the position of the observer's eyes relative to the transparent screen comprises:
receiving input from the observer, the input indicating the position of the observer's eyes;
based on the input, determining a vertical coordinate of the observer's eyes and a horizontal coordinate of the observer's eyes; and
storing, as a position of the observer's eyes, the vertical coordinate and the horizontal coordinate.

23. The method of claim 22, wherein determining the direction of the light source relative to the transparent screen comprises:
detecting, using a positioning device, a position and an orientation of the transparent screen; and
based on the position and the orientation and time of day, determining the position of the light source relative to the positioning device, wherein the position of the light source comprises a vector; and, optionally:
wherein the vector comprises (1) an angle between the horizontal axis and an axis created between the positioning device and the light source's position, and (2) a direction; and/or
the method further comprising:
detecting an electronic device;
determining that the electronic device includes a global positioning system module and an accelerometer; and
setting the electronic device as the positioning device.

24.-25. (canceled)

26. The method of claim 22, wherein identifying the area of the transparent screen where light emitted by the light source intersects the transparent screen before reaching the position of the observer's eyes comprises:
modifying, based on the position of the observer's eyes, the vector such that the vector represents the light source's position relative to the observer's eyes;
identifying, using the vector, a point on the transparent screen where the light emitted by the light source intersects the transparent screen before reaching the position of the observer's eyes; and
selecting an area proximate to the point; and, optionally:
wherein selecting an area proximate to the point comprises:
determining, from the input, an area associated with the observer's eyes; and
selecting the area proximate to the point based on the area associated with the observer's eyes.

27. (canceled)

28. The method of claim 15, wherein causing the area of the transparent screen to be modified such that the light emitted by the light source is dimmed in the area of the transparent screen comprises one or more of:
applying current to a portion of a matrix of electrochromic material integrated into the transparent screen, wherein each portion of the matrix of electrochromic material is addressable;
applying a current to a portion of a matrix of liquid crystal material, wherein each portion of the matrix of liquid crystal material is addressable; or
projecting an electromagnetic beam onto the portion of the transparent screen, wherein the transparent screen comprises material that dims light emitted by the light source when the electromagnetic beam is projected onto the material.

29. (canceled)

30. A system comprising:
a transparent screen; and
control circuitry configured to:
determine a position of an observer's eyes relative to the transparent screen;
determine, using an imaging device, a position of a light source relative to the transparent screen, wherein the light source produces at least a threshold intensity;
identify, based on the position of the observer's eyes and the position of the light source, an area of the transparent screen where light emitted by the light source intersects the transparent screen before reaching the position of the observer's eyes; and
cause the area of the transparent screen to be modified such that the light emitted by the light source is dimmed in the area of the transparent screen.
